(19) United States
(12) Patent Application Publication
(10) Pub. No.: US 2017/0160507 A1
(43) Pub. Date: Jun. 8, 2017

(54) ENHANCED DUCTS AND DUCT BANK SYSTEMS

(71) Applicant: Lawrence F Glaser, Fairfax Station, VA (US)

(72) Inventor: Lawrence F Glaser, Fairfax Station, VA (US)

(21) Appl. No.: 15/101,983

(22) PCT Filed: Dec. 8, 2014
(86) PCT No.: PCT/US14/69016

§ 371 Date: Jul. 29, 2016

Related U.S. Application Data
(60) Provisional application No. 61/913,508, filed on Dec. 9, 2013.

(51) Int. Cl. G02B 6/44; F16L 1/032; H01B 7/18; G02B 6/50; H02G 1/08

(52) U.S. Cl. CPC G02B 6/4459; G02B 6/508; H02G 1/081; H01B 7/1805; F16L 1/032; F16L 2101/12

(57) ABSTRACT

The present invention relates to cable conduit systems, and in particular conduit systems which provide novel, enhanced features to improve installation, higher occupancy density and facilitate selective removal of cables.

### BACKGROUND

In prior systems, due to the shape of the ducts and the pulling technique used for such ducts (conduits), gravity locks the cables together with maximum force. As cables sit over time, the cables can become locked together or welded together by mud and dirt. Cables can be twisted and intertwined during installation such that trying to later pull (remove) a selected cable is many times found to be impossible. Damage occurs between cables while trying to individually extract them in a, typical legacy conduit system. Damage can also occur when installing more cable in an already occupied conduit pathway. Friction between cables is one cause, passing through knots and entanglements is another cause of friction and damage. Many heavy cables are pulled in with machinery which cannot alert the operator that tensions are fluctuating enough to indicate damage caused to another cable in the duct.

Users of cable duct systems, especially commercial, government and institutional, continuously develop their campuses or maps and plans, to support their changing cable network requirements, making new and expanded inter-building and intra-building underground or buried improvements. During these improvements, despite the best planning, untimely negative events occur such as cutting gas lines, damaging or cutting fiber cables which are later hard to detect, damaging other duct species, and the need arises to cut parking lots and the like, jack steel pipes under loads, walkways and roadways and set more manholes as a result of the demands for expansion. Over time, new cables are required and old ones become outdated, but making changes to existing conduit systems and expanding them, has been difficult and enormously expensive, when all factors are taken into consideration.

Some prior art attempts to enforce some order on cables by adding a piece of hardware. Unfortunately, the additional hardware causes complications such as a reduction in bend radius and, though it may add to ease of cable removal, makes the job of fishing a new cable a near impossibility: For example, U.S. Pat. No. 5,605,419 (Reinert) or U.S. Pat. No. 7,806,629. (McCoy) furthermore, almost all the old duct systems were round (and all exterior systems are round) such as U.S. Pat. No. 7,614,427 (McKane) or, in attempting to prevent inadvertent bundling by distributing cables laterally, made use of complicated anchoring and access arrangements, such as U.S. Pat. No. 6,972,367 (Federspiel) or required complex retaining and packing apparatus to get 100% fill, such as U.S. Pat. No. 6,627,817 (Kortenbach) Others lack flexibility, such as U.S. Pat. No. 6,476,327 (Bernard) or are not accessible from the ends and so can't be rethreaded, such as U.S. Pat. No. 5,824,957 (Holshausen) other systems were square in cross-section, such as U.S. Pat. No. 4,937,400 (Williams) The concrete duct prior art focuses solely on details of the filler.

The use of 45 and 90 degree pre-curved pieces and heating the (PVC) type pipe to custom bend in the field are popular methods and they put kinks or distortions in the pull. Even when the kink is minor, it adds stress for cable pulling. Distortion reduces duct capacity and increases friction.

### SUMMARY

The present invention pertains to a cast concrete duct system, buried ducts and open ducting including external to and inside of buildings or other structures, intending to carry power, communications or smaller fluid lines, which will provide substantial savings for major construction projects such as government, campuses, airports, military, long roadways and any project requiring exterior ducts or interior ducts.

Any way of making changes to existing conduit systems which absolutely maximizes use of all available existing space, provides for heat dissipation for electrical cabling even when the main duct is 100% occupied, allows for 100% occupancy for fiber optics or low voltage type cables and still allows for selective removal with greater ease, as well as spontaneously installation of new cable or tuning while removing old, will be deemed to be of enormous value to the Architect, Engineer, Planner, Designer, Owner and final occupant of a campus or multi-building complex, particularly when the costs for a superior conduit system are comparable to the established method. Staving off addition of conduit can save a project many millions, tens of millions or even hundreds of millions of future dollars, much more than the cost of the initial system, not to mention avoiding damage and down time with particular emphasis on the accidental damage to fiber or power, communications (lines), gas lines, the associated outages and repairs and the difficulty in running MV or HV cabling. (Medium Voltage, or High Voltage). The solution provided here, addresses any and all need for access-ways which includes passages for cable, flex pipe, smaller piping, wiring and any other need for a conduit-like passageway. In a hospital setting, this invention could literally save lives and improve the lives of the patients, due to less down time potential, as but one example.

The present invention provides a substantial minimization of stress over the prior art because, in an embodiment, one can optionally engineer all components per the 3-D topologic layout of the campus, particularly when the client cannot provide a flat or reasonably planar pathway between all necessary interconnected points in a given setting.

The new invention is in part, the novel shape of the duct and the “tilt angle” maintained through any rise, essentially, any curve with respect to where the center of gravity will preside and how the cables are distributed cross-sectionally. The center of gravity for each cable is also taken into consideration with gravity being the primary force at work determining the final lay of the cable. The methods of casting in place or pre-casting duct banks in segments, or open installation inside buildings and structures are well known to those of skill. This duct shape, it's side duct (minor service duct part of the whole pathway) and it's features are however, novel and unique. The thickness of the walls of the ducts depends upon the materials selected, such as PVC (Polymer based) or metals (such as stainless steel or plated steel) and are guided by industry standards for general production of conduit and pipe, wherein, this invention is perfectly compatible with those published specifications. Examples are the common schedules, such as Schedule 40 or 80 as published through standards bodies such as ANSII, NEMA and IEEE.

The present invention applies to all cables; power, communications and other utility type pathways. It applies to multi-irrigation lines, gas tube or pipe (carriage), liquid tube or pipe (carriage). Industrial applications include handling of differing gases and liquids so the conduit ducts, lines and their materials may differ. (eg plastics, metals, composite materials, polymers, rubber, synthetic or silicon based) Pulling in new lines to handle certain requirements, for example, at a refinery or oil-rig, is extremely beneficial in this setting. Time and expense is radically reduced. Supplanting of old style conduit and lines, cables and so forth, is mandated, supported and enforced with this system.

The selective addition of symmetrical grooving to the inner walls of the major and minor service duct provides for traction for robots (manual push shuttles and self propelled robotic shuttles) which may traverse the conduit line internally. Robots can pull in lines, be equipped with cameras (lighting) and other remote controllable tools as well as pulling in a flex tube temporarily for dispensing lubrication or directly dispensing lubrication. A robot or shuttle scaled to the size and shape of any duct or a duct portion could be engineered to perform these tasks. It is possible a pulling robot could pull in a line or cable, even if a secondary power line is required to power the robot over the length of the pull. A power line could be added to the minor duct, in the form of a pair of tracks (not illustrated) where the robot must be in contact with these tracks to derive its power. The tracks are only powered when the robot is needed for pulling or to provide power to a robot needing to perform other tasks where a local battery on board the robot cannot fulfill due to battery power limitations. (eg to deliver enough raw pulling horsepower) If a power cable is needed to power a robotic puller, the power cable can follow the puller through and be removed when the pull is complete. The power cable could also be left and reused creatively, for the next pull through the same duct or, used to pull in a pull line, measuring tape duct liner, innerduct or cable. Here again, time and labor are saved on a complex job.

Gravity is a key operative factor as is the conduit shape and interior shape of the conduit wall(s), assuring the later installed cables sit orderly on one another as they are pulled in, never as deep a stack as will be encountered with a round or vertically oriented oval duct of the same cross sectional surface area, one can thus add and subtract cables with greater ease and no fear of finding impossible-to-remove segments. A side (service) duct is provided which allows for inspection, even distribution of cable pulling lubricant and the ability to perform “minor surgery” in an in situ cable or tube including inspecting and undoing a tangle or other impediment, for example, selectively remove a stone or foreign object.

The purpose of the system is to achieve full conduit occupancy without compromise to any other major factor normally encountered in legacy conduit systems. The achievement of full conduit occupancy for cables or other items which produce heat has suggested a heat sink be provided as part of the conduit itself. For purpose of assuring good thermal contact with the heat sink, the conduit can be filled when the cable is pulled in, with fillers that possess the thermal transfer properties advantageous to the transfer of heat from the cables or other heat producing occupants to the heat sink in the wall of the conduit. Other uses of the same fill could include providing a fill with very slight electrical properties permitting the monitoring of the fill's resistance to determine if there is tampering with the fill implying tampering with the contents of a conduit duct. A fill dissolver or remover could be developed which is a liquid chemical that can dissolve the fill and allow removal through gravity or pumping. The conduit line could be assembled and installed in such a manner as to permit pressurization or placement of a vacuum which holds stable, long term. This is another condition which could be monitored with sensors to determine any change in pressure or vacuum and report it electronically.

### BRIEF DESCRIPTION OF THE DRAWINGS

FIG. 1 (prior art) shows populated conduit of the conventional type. There is no way to run a rod or steel tape through a heavily populated conduit. Ducts are at about 50% occupancy and sometimes removing a dead cable risks damage to other cabling. Even only 2 cables in a conduit could pose this problem if they intertwined during installation.

FIG. 2 shows conduit or duct 100.

FIG. 3 shows embodiments and features of the duct 100 of FIG. 2

FIG. 4 shows an improved embodiment of a universal form factor conduit of the present invention.

FIG. 5 shows the universal form factor conduit of the present invention enclosing multiple ducts 200

FIG. 6 illustrates bends between manhole “vaults” and bending strategies. If and where necessary if a tilt or angle was required to approach vertical and then pass through a vertical position to angle or tilt in the opposite direction, the emphasis will still remain upon the fact that the vast majority of the run still places the cables at different longitudinal placement relative to one another and avoids the kind of stacking seen in a round conduit. The point is the invention works even when oriented perfectly vertical, however, its most preferred embodiment is to find the best angle to promote the least number of cables on top of one another, distributing weight and reducing friction while allowing clear passage of the observation shuttle.

FIG. 7A, 7B (prior art) note all square or round, no shuttle bay that ties in, no way to run a rod or steel tape once there is medium to heavy occupancy, invariably allow no more than 60% capacity. Plural concrete ducts are typically poured in place and there is some use of precast plural ducts as well.

FIG. 8 shows the successive progress of installing 2 cables within the invention.

FIG. 9 shows as a natural progression from the effect demonstrated in FIG. 8, adding more cables promotes orderly stacking. Selective removal of one cable resulted in a shift of the remaining cables to keep the stack orderly and to transfer the center of gravity of each cable to a position more favorable than if the conduit were perfectly round providing the same net useable volume as the invention. Note that for power cables the round conduit has to be considerably larger in volume and takes up more space because of the lack of a heat sink or any other heat removal or distribution means built into the conduit.

FIG. 10 shows the use of a special shuttle more likely to be used to assure the cable just installed is fully sitting as desired.

FIG. 11 shows how a steel rod can be used in place of a rope for specific tasks.

FIG. 12 shows that braces can be useful to hold the ducts in a given placement for burial, or for encasement in a media 1210

FIG. 13 shows further progression of FIG. 12 where pinning is needed to assure no shift during a heavy concrete pour.

FIG. 14 shows the efficiency spread of lubrication from a shuttle equipped to deliver lubrication.

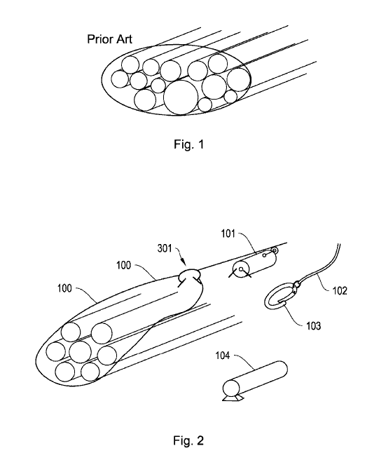

### DETAILED DESCRIPTION

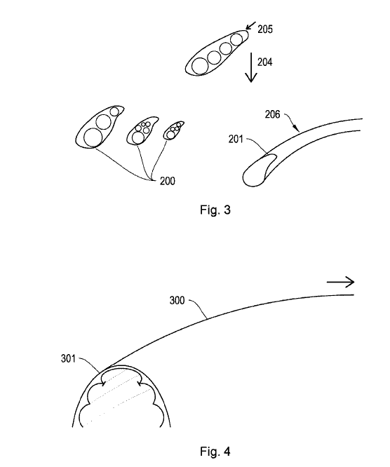

Referring to FIG. 2, any one cable or occupying line or tube within the duct can be removed at any time because they are not twisted and the wall angle or tilt selected when the conduit was engineered and placed evenly supports some of the weight and distributes the friction involved. The pathway can be inspected end to end and also lubricated end to end. Even during pulling, the line can be inspected end to end. This is done with a shuttle that can spray cable lube directly over all the cables. This function is useful if it's an older install and the cables are dry. The shuttle can also run a camera alone or concurrent with the lube spray to inspect and make sure conditions needed for the addition of a new cable, or the readiness to remove an old cable are as good as possible before performing the work. Reticulations are formed on the wall of the conduit or duct 100 engineered to be positioned in places most likely to handle the friction during pulling. This could become a sophisticated computer aided design concept where the reticulations are determined once an engineer provides the specifications of the cable to be installed in each duct and in what order they will be installed. Custom formed reticulations would benefit the installers slightly and the reticulation curvature and thickness can be varied based on all known factors such as the complement of cables, their weight and friction coefficient and any mix of future cables which will potentially be installed in any given conduit.

In an embodiment, another feature of the invention is that, once a first cable is inserted, a shuttle form digital camera 104 is provided. It may be equipped with a light for back lighting. (light not shown) Robot 101 is disposed in the side duct 301 (shuttle pathway) which may pass through and monitor how the new cable sits, and it becomes possible to pull from each end and force a new cable to drop or just work out kinks. This way, it may be seen how the cable finally sits end to end. Equally, when you approach a duct and cabling you have never inspected, this invention allows for inspection of the in-place cables so as to know what you are going to be dealing with, how your pull rope sits once you place the pull rope, ease the placement of the pull rope and absolutely assure, all the cables you will be pulling adjacent to the existing, and the new cables as well, are well lubricated over their entire surface. It is notable, the industry surrounding this invention is a multi-billion dollar industry arguably exceeding 1 trillion of annual outlay for support of ducts and conduits in all man made structures and pathways. Improvements are anticipated in all aspects of the engineering, placement, use and maintenance of these types of duct, and most importantly, the avoidance of expansion where there is now going to be much greater capacity per volume of usable longitudinal conduit space and, the en masse space between any two points on a given plat, campus or building.

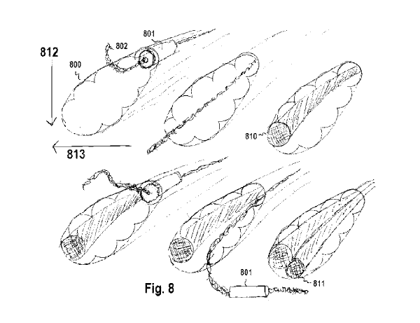

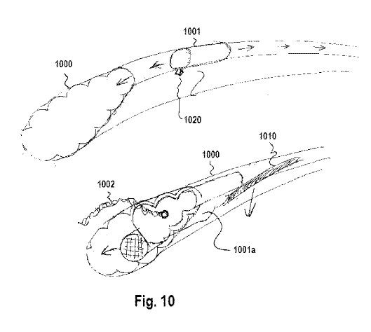

The camera is attached to a pulling rope or cable 102 by a snap ring 103. The camera can also ride in the main duct 100 with an adaptor. During removal, by way of the shape and design, the present invention enforces, at all times, much less cable above any bottom cable assuring a lower overall coefficient of friction as compared to round conduits. Depicted here and in greater detail below in connection with FIGS. 8 and 10, is the act of pulling in a pull string, then pull rope using a shuttle that rides the smaller passageway. This assures the pull rope is not tangled and can always be run the length of the passageway without getting intertwined with the existing cables). In an embodiment, one can push a shuttle through with a steel rod or tape. The small duct assures the tip of the tape or rod cannot come loose and hook or stab anything at all, or become immobile before it reaches the end of the conduit. When retraction is effected with a line on the end, that line must, in all settings, be on top of all cables in the conduit. This is a big factor in favor of the design of this solution.

Referring now to FIG. 3, sizing ducts 200 ensure that cables remain orderly. Duct 201 (CAD-Computer Aided Design) smoothes curves 206. The action of gravity 204 interacts with tilt angle 205. A high slant assures lower friction between cables for enabling removal. Once occupied, a tube may be pulled in into the shuttle pathway and then one can occupy that with cable, probably fiber optic as with innerduct but this is not mandatory. The tube. could be copper or a fluidic or gas utility line. This invention is intended to support any line at all: copper, fiber, communications, power and even liquid and gas lines. This cannot be done, however, if the main cables in a given duct need the excess air space for heat dissipation. A table can be generated and provided depicting heat transfer characteristics for any conduit formed from this invention based on voltage, current heat dissipation (air flow), anticipated atmosphere and altitude, exposure to natural elements and the cable manufacturer's specifications for this, determined by their UL approval NEC and IEEE recommendations

This solution is novel because existing systems offer no means to assure cables do not tangle, there is no way to inspect the cables inside the ducts, in place, and for the most part invariably require that when one cable is pulled to try to remove it, they all move with it and individual selective removal just cannot be done without a grievous investment in time and down time, as the cables typically then all have to be cut, pulled out, the new cables pulled in with the old at the same time and the damage re-spliced and re-tested along with the associated outages this specifically implies. It is interesting to note this happens to whatever is in the conduit, be it copper, fiber, radio, gas line or tubing, power cable, the logic remains the same. Management of many in a single duct always leads to these issues, which this invention solves for. If installers are required in the old systems to cut all cables or items, remove them, reinstall with the new cables along side, that process repeats the same issue, should they come back one day later because the end user needed just one more cable, they may have to repeat the entire process of cutting, removing all and reinstalling then splicing, doubling the down time. The invention solves for this.

Referring now to FIG. 4, this system assures filling to 100% and then selective removal is still supported, unlike the current case in which the kinks and incompatibilities of various cable types assure no duct is ever 100% full. Selective removal under this new system can mean that a new cable or line is pulled in exactly concurrent with the removal of the old, in one step. This is possible because there are no twists or tangles and friction, as caused by cables on top, is minimized to the logical minimum by design. It is most notable, because of the non-symmetric shape, one must calculate the cross section area to find it's the same as a round duct while greatly reducing how many cables sit on top of any one bottom cable, no matter how full the duct is. The non symmetrical aspect, provides this very valuable feature but still allows a plurality of ducts to occupy the same square or rectangular cross section of a collective of these conduits, be they encased in a medium such as concrete as found in external applications, or grouped along a pathway inside a structure. The status inside each conduit can be seen with the camera and provide additional assurance that this is so; the old cable may be pulled slightly to verify that it moves without taking or dragging all the others. The entire length of the pull with the shuttle, can be lubricated and it is a simple factor to check if the size of the new cable is equal or less than the one being removed, of if larger, that the old cable will be strong enough to facilite the simultaneous replacement even if the new cable is bigger, and the remaining cables can shift based on the conduit volume and size as well as length. The new cable would be lubricated at the same time while the old is removed.

Shape plus tilt of the conduit (invention) assures cables sit partly on duct and partly on each other. For the same cross sectional area, no round conduit can compare as the bottom most cables in a 50% or better fill will always have more than 2 times the friction along the entire length, because there is at least 2 times more weight on top causing one of the many problems cited in this spec which are solved by this invention.

Industrial applications for such systems account for billions of dollars per year. A more efficient solution universally saves the customers billions of dollars, and will almost always save more money than the cost of the system as measured over its realistic useful life (50 years+).

It should be noted this solution is proposed for precast segments, build in place, pour in place and for any other setting where one finds conduit, even inside buildings.

The duct wall is preferably of a lower friction coefficient than the cable sheath. The shuttle bay 301 and a sizable pull cable or rope assures no tangles or twists between cables or cable bundles. Shuttle bay has a known passage to the larger bay so the pull rope always ends up in the larger bay—on top of all cables. Smaller cables can be bundled together with a machine that puts a simple wrap on them. (lacing machine, binding or lashing) They would have to be removed as a group if replacement or repair is needed in the future so for installation and de-installation, that form of cabling appears as if it were one cable. The shuttle bay is accessible to facilitate 100% full capacity of the conduit system all-inclusive, for all. Pulling out any cable assures the others will drop from gravity and fill in, plus adding a new cable on top, when one was just pulled out, presses all of the cables down by way of gravity, weight and the shape of the duct plus its cross sectional tilt. The scalloped shape, or ‘reticulations’, or symmetrical grooving of the underside assures the down pressure is supported with a net sum total of less weight when you form a vector pointing to the force of gravity and analyze friction. There are simply less cables directly on top of one another but still, the same cross sectional area as a round duct, hence, the same or greater capacity.

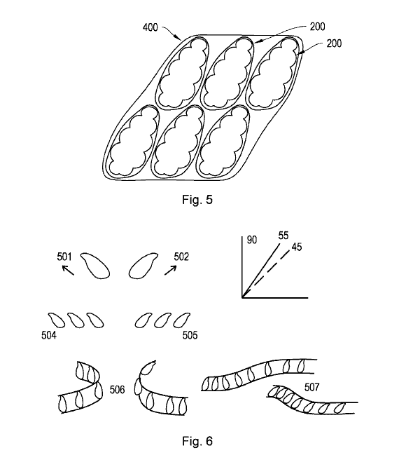

Referring now to FIG. 5, The invention discussed previously in connection with FIG. 3 shows subdividing, but, in an embodiment, (see FIG. 5) one could bundle, as an example, 4 together into one unit holding to all the shape, features, etc. . . . .

The removal or install process puts a dynamic pressure on the cable being installed such that it hugs the curves and walls and keeps friction off the surrounding cables. A heavy cable under tension routinely and predictably behaves a certain specific way and this system leverages that behavior . . . the tension on the cable necessary to move it, assures it rises up against the inner curve wall or in a straight pull, in an embodiment, one can set the height in the duct during the pull. This assures no twists, tangles, even stacking and easy removal. The present invention allows unprecedented use of 100% of the capacity and ability to selectively remove any cable and, further, enables great versatility to permit features such as, for example, double or triple bends. Rises and falls are enabled in a similar way. Even a requirement to bend a conduit first one way, then the other, accompanied by some custom shaping, is better enabled.

An important feature of the invention is the reduction of friction between cables. So much so, one can remove a cable selectively and then re-install a new cable while currently, with the round prior art ducts, in most situations of significant severity, changing existing cables means leaving a stub of the old cable in the conduit. Once the conduit is installed, or when a conduit si not occupied, a reamer or grinder tool can be provided for the minor and major duct portions, (shuttle bay and main bay) which assures no burrs or restrictions, unanticipated changes in cross sectional configuration. Reaming or grinding in place would also be better supported with a vacuum attachment for the shuttle bay which can clean that bay and the main bay with reliability, both wet and dry debris (for example, with a wet vac that is electrically safe in manholes). The tool for this could be engineered so that it cannot take out appreciable material, or, in another embodiment, the reaming and grinding tool could be hyper aggressive and take out all of the conduit leaving only a very thin remainder, for conduits encased in a medium, such as concrete, which would not lose the shape of the pathway. Thereafter, the pathway could be recoated with a thin material, such as a polymer. This advantageous idea is seen as one which could be more typically deployed in future years, to further expand the capacity of a duct system, or, as a last resort to clear a pathway which may have become fractured due to other construction or earth quake or fault.

The shuttle 104 that passes through can be a camera for internal viewing to see if there is dirt, if cables are twisted, to carry in a tool and camera to try to push out a knot or kink and, to carry a spray device with the camera so spraying the cables with lubrication and inspecting is accomplished at the same time camera pass. It may be battery powered, ride a power track embedded in the wall of the ducts or drag behind a light power cable that can be strengthened (eg Kevlar strength member is a popular method, or nylon rot resistant cord) to act as an emergency pull for instances when the robot breaks down or the battery simply dies.

The shuttle pathway is very unique and can be used if all else is full, to carry cables. A shuttle could put in and pulled in a full fledged thin wall conduit into the shuttle pathway so it becomes a closed tube, then fill it with cable or other permissible content This may be impractical for voltage cables as they require space for heat dissipation, however, the heat sink in an embodiment, provided in the wall of the ducts, will still provide much greater occupancy than standard round or oval ducts. Through calculation of the cable's specifications under load, the viability of the heat sink to handle the heat along with calculation of the preexisting cables and their load, allows one to determine if the final space in the service duct could be used for cable, when necessary.

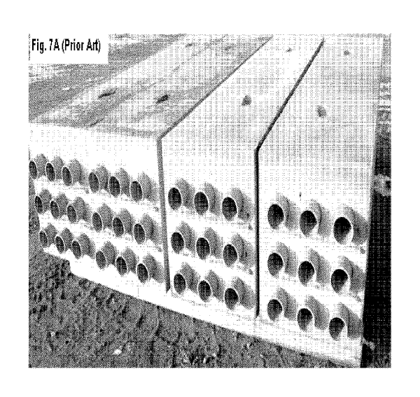

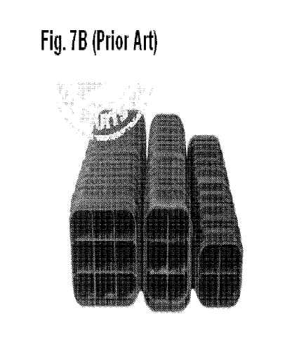

FIG. 6 illustrates bends between manhole “vaults” and bending strategies as related to slant or tilt direction and angle of slant or tilt and run. The tilt angle 503 is preferably between about 45 and 55 deg. If there is no bend angle between vaults, the direction may be either of the two possible, 501 or 502. For multiple conduits 505, all angles preferably go the same direction. For sharp bends 506, they may all be vertical and return after the bend to an angled slant. In order to return properly, the conduit must have sufficient torsional rigidity, while leaning supported against a cavity or adjacent conduit, to let the action of gravity favor the cross-sectional centers of the cables it houses to adopting an enhanced offset relation with respect to vertical. (to spread out) This is done by keeping the major elliptical axis of the conduit in sufficiently angled orientation 501. (with respect to vertical) However, the conduit must have less torsional rigidity (for at least a portion of its length, in other words a ‘torsional rigidity per unit length’) than would prevent it from passing through a vertical orientation, to adopt a new orientation 502 following a bend 506

The lining of a conduit can vary as to material. Friction coefficient, presence of ground water and the types of cables or other items to be installed will guide in the selection of these materials. Materials such as nylon or other polymers will be good candidates if a duct is to be lined with a second material. Generally, the conduits will be made from pvc pipe, extrusion produced, which benefits from the present invention because the extrusion process lends itself to the shape of the invention while not appreciably changing cost to produce Metals, such as plated steel are also anticipated for use in manufacturing the invention. Metal ducts, particularly when encased in concrete, could also be reamed or ground but this clearly would require different heads on the grinding and reaming apparatus. The angles or tilt in sharp turns may be other than 0 degrees perfectly vertical. The running lengths will probably be best at 45 to 65 degrees. An engineer (or computer software) can calculate the angle 205 based on the kind of cable and friction coefficient. To assure the interior portion of the invention is consistently maintained as to its configuration, the major and minor duct portions can be reamed after bending to absolutely guarantee no imperfections and a consistent cross sectional volume is achieved throughout the entire length of the conduit. The minor duct is even useful here, for camera recorded inspection of each bent and straight duct produced. If each piece is uniquely marked, such as with bar code, the camera can be required to store each bar code and associate each video or image taken with the unique bar code, unique identifier and hold this data in a data base. This way, future imperfections can be isolated to manufacturing, storage, shipping and packing or in field issues during installation. The install can be verified automatically, from the data base, in terms of which piece was placed where in the system to avoid mistake by the installers. This step would be recommended as one assembles the conduits one by one, well before pouring concrete.

The shuttle 104, in embodiments, passes through the top access duct with both a camera and a pulling lubrication. Further embodiments provide a shuttle with a camera and tools to nudge cables and remove some kinks, possibly a claw to grab a stone. Stones get into these systems from time to time. In some embodiments, a pressure wash to clean with water or other liquid detergent, a vacuum/blower-adapted shuttle is provided for cleaning empty pipes and in some cases, occupied pipes can be cleaned too. Yet further embodiments include a compressed air shuttle to clean a duct, a camera for viewing the larger duct and look ahead or behind, in the shuttle duct itself, tools for nudging cables, a small cutter resembling a high leverage nipper, lines could get caught. The present invention literally provides for cut strategic places and releasing the lines. Still further embodiments provide a shuttle add on for spraying lubricant into the shuttle conduit or the main conduit selectively, or a grinding tool.

The shuttle's main purpose is to take a pull rope through, inspect or pull cable and provide lubrication to the pathway. The pathway is assured when the line is in and present end to end, tugging on the line back and forth assures it is released from the channel and falls into the conduit. That assures the pull rope is on top of all cables and not tangled around them. Then, the shuttle with the camera can be run through to “see” the rope and how it is situated prior to pulling. It is even possible to hook up the cable, start the pull or tension it, then run the shuttle through with the camera and inspect the situation as many times during the pull, as necessary. It is possible one could install a pull rope large enough to stay contained in the shuttle bay and then pull in a cable which is known to have a diameter which will allow the cable to drop out by way of gravity or using a tool to follow behind and push the cable out of the shuttle bay into the main bay, once the cable is in, end to end. This is a nice practice as the pulling stress tends to take out bends and kinks, so when the cable drops it is “denatured” and will sit will in the main duct, with no loops or kinks.

An ideal example of savings is on a campus with ducts under a railroad or major highway. If even just the addition of one duct is saved, it could easily be 1 million dollars plus the disruption of traffic and accidental outages caused in other facilities along the same pathway are sometimes incalculable as to the cost. Furthermore, recycling or reclaiming dead cable is possible because it can be economically removed, thus enhancing ecological considerations. The grinder application could be enhanced to grind out cables in place and use a vacuum to remove the debris, intended for capture and recycling. This is a very efficient solution to the reclamation of the space and of the cable inside intended for melt—recycling. In one step (grinding) the conduit shape and consistency is assured while all cables inside are reclaimed as to the raw material.

A circle or rectangle duct invites gravity to critically play in. There is also currently no means to look into the duct once there is a certain percentage of occupancy, by estimation about 20%. If the same cross sectional area (surface area of a cross section) is taken and reshaped to mitigate gravity's effects, this allows gravity it help rather than hinder. Gravity helps in this design because the cables are always typically heavy, be they copper, aluminum, even fiber, they are dense and heavy along their length. So, when placed on what functions like a sliding board or chute they will slide, particularly when they are pulled in. This is because of gravity, forces applied and lubrication. The secondary service duct or top artifice could be added to a circle or square duct. A very important feature of the non round invention psed here, is that adding the extra small duct to a circular or square duct allows for similar features, but the cable lay, the orderly nature and ease of removing, plus going for 100% fill, those features will not be there.

When ducts of this invention are grouped together, harm is not done to the pour; the integrity of pour in place for duct bank systems, and in precast, same thing, there is no change in structural strength, based on the attributes of the invention.

Additionally, for power cables, the small portion of the FIG. 8 cross section is to be left open for air flow, meeting UL and Electrical Code requirements for cooling as all power cables emit heat. The sizing of the small shuttle duct versus the larger portion that carries cable can be engineered to determine, based on voltage in the cables (and current) what size moves the heat efficiently. Furthermore it would be possible to build in a heat sink into the duct to move heat into the smaller duct more efficiently, embedded into the walls of the conduit. Aluminum, aluminum powder, copper, copper powder, even pot metal blends will be suitable and still maintain structural integrity. Elsewhere it is discussed to dam the ends of a conduit, fill the run with a compound and the compound could have water repel and heat transfer properties, thermally connecting all cables in a conduit to the conduit wall and any heat sink in that wall, rather than to rely upon the trapped gasses (atmosphere) in a given conduit to perform thermal coupling and heat transfer.

Some embodiments would have grooves between them into which rebar could be inserted and then the grooves filled with poured concrete. The invention provides the strength and stability of a poured product, but super install speed so a campus or facility is less disrupted by digging, repaving etc. More can be done each 24 hours. The concrete drying strength is no longer a factor as it's only there to bond the elements together. The strength comes from the precasts and their interlocking. The pour is just to keep a duct bank it in place, such as during an earth quake or for compaction over time, avoiding undue settlement. In some embodiments, precast segments are placed into a properly excavated hole to link up with each other. This is popular for a pour in place install for passing under a roadway, so there is not set up or cure time needed, the roadway can be repaired immediately after dropping in precise segments.

In some embodiments of the invention, a series of shuttles ride inside the smaller service conduit and hold the pulling rope or pulling cable. A cable may be introduced with coating as a puller, where in some conditions no humans can be in the hole or vault while pulling, which is OK because all the big pulling machines have remotes for that reason, but the industry still prefers rope. Rope or high tensile rust proof cable could be used for pulling. The small conduit holds a series of shuttles spaced out so that they hold the pulling rope or cable away from the existing cables in the duct, so it is possible to pull in a new cable with little friction or no friction against the old cables and a certain pathway, in that the cable will now lay on top of the others without having forced them apart. Its good for the cable and good for removal later. Removal of any cable in the duct at any time, is the hallmark of the invention plus moving heat for power situations. The present invention allows 95% to 100% fill and easy removal at all levels of occupancy. This would be especially good for large, changing installations such as the military might use.

Since the two ducts are connected, for a high speed shuttle, it is necessary to have a small, light weight and strong hose to follow behind the shuttle so it can move under compressed air along its duct. Like a jet engine, compressed air will propel it the needed distance. This is in addition to the provision of duct repeating carvings on the inner wall which provide for traction or gearing, if, in an embodiment, a cable pulling device is used that pulls ahead of the cable, through the duct. (eg robot designed to do this for quick install, usually for lighter cables but not necessarily limited to light weight cables) National Electric Code limits most apps to 300′, but this solution could go further. For very long hauls, in an embodiment, the present invention could have a shuttle with a light weight electric wire trailing and wheels, using electricity to pull in a pull string. The small duct attached to the larger in the manner provided, is a revolutionary improvement allowing for much more rapid fishing in of pull lines.

In an embodiment, the present invention provides nylon rollers or friction plates at key turn positions so when the cables are tensed, at those centers of gravity where the cable must “pop” or “tense” and hit the side (logic dictates the place this will happen, a computer can calculate it accurately, it's just force vectors), the feature is there in a nylon “bearing” or just a surface with deliberately very low friction (even if fixed) which will greatly facilitate future additions by getting the friction low where the cable is most tense and presses the side the hardest. Many of these kinds of systems end up totally under water. It's the nature of the industry. High water tables, excessive rain, natural springs, broken water or sewer pipes, decades between entry, it all adds up in terms of actual wear and tear, increase in friction and adding to difficulty in adding or removing cables.

The service ducts can be connected to one another, from point of origin to point of destination via interconnection in all hand holes, manholes or anywhere the duct would otherwise have a break in it, as planned. In this manner, a robot camera can traverse an entire line. At one end of the line or the remaining end, or in combination, different ducts could also interconnect their service duct so a single robot can traverse the entire duct system for purpose of surveillance and maintenance. The camera can include IR capability so as to see well in utter darkness and may be water proof and able to perform its duties fully submerged.

The side cuts present in the ducts for purpose of providing traction for puller robots or camera robots need to be deep enough to allow for minor reaming to keep the shape of the duct uniform while still leaving enough depth to be of function, providing certain traction for the passing robots.

The duct wall can contain a material with electrical properties such that disturbance of the duct, once installed, will register on a proximity detector. In this manner, all ducts may be interconnected and have one proximity detector to detect cutting or tampering with the duct. If a conductive mesh is used, time domain reflectometer technology can also tell the distance to the disturbance. The robot camera can be told via a wire or wireless network and immediately relocate to the region of disturbance to then capture video or photo and audio data for inspection.

Another direction of use for this invention is to use a certain thickness of wall for the ducts and once in place, strictly for cast in place or cast systems, the ducts could be re-reamed with a grinding tool optimally shaped to fit the existing pathway (with no cable in it) This thins the wall but it matters not as the system is encased in concrete. It does not compromise the integrity of the ducts, eg make them weaker. Concrete and its iron and steel reinforcement is 20-100 times stronger so the duct is really meaningless when there is a cast system in use and the duct is inside the castings.

The present invention also provides an improvement for the task of removing and destroying cable in place, in a duct. A specialized grinder could grind, suck with vacuum and high density contractor bag the existing cables in a duct, in place. Recycling will surely be advised for both copper and fiber. The glass found in fiber optics still has intrinsic value as it was purified prior to manufacture, so the grindings could be recycled with great ease, as well as copper, aluminum, essentially anything encountered in a duct while removing. This will save labor and time and reinforce the need to recycle, providing a very green and desirable solution to the process of cable removal.

FIG. 8 shows the successive progress of installing 2 cables. Elements involved are the duct 800, shuttle 801, pulling rope 802, first cable 810 and second cable 811. The direction of gravity 812 and pulling direction 813 are shown on the left with arrows depicting the direction of force.

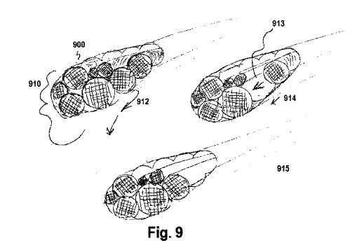

FIG. 9 shows as a natural progression from the effect demonstrated in FIG. 8, adding more cables promotes orderly stacking. The pulling forces and gravity forces are not shown but logically, they exist and are the same as in FIG. 8. The elements are 900 which is an occupied duct, the various cables that occupy the duct are shown as 910, removal of a specific cable shown as direction 912 results in a natural rearrangement of the remaining cables shown as 913. It is mentioned on the right (direction 914) gravity or a special shaped shuttle assists the remaining cables in assuming the final required efficient arrangement. This figure is intended to bring attention to the fact that cable 912 could not be removed in a conventional setting due to being twisted with other cables or too subject to friction from above cables to remove independently without damage to the cable 912 or surrounding cables 910 and with no inspection method to see why a given cable will not move or to evenly apply lubricant. The result 915 is a clean, orderly, controlled fill.

FIG. 10 shows the use of a special shuttle more likely to be used to assure the cable just installed is fully sitting as desired so remaining cables will be easier to install and to remove later. The elements shown are a duct 1000, s shuttle 1001, a special form fitted and shaped shuttle 1001a, pulling rope 1002, a single cable 1010 and a camera 1020 on the shuttle for inspection of the duct end to end. It should be clear a cable installed can immediately be inspected and if it requires a nudge to get to the deepest recess of the duct, the special shape shuttle is used. In an embodiment, one can push a shuttle through with a steel rod or tape. The small duct assures the tip of the tape or rod cannot come loose and hook anything at all. So when retraction is effected with a line on the end, that line must, in all settings, be on top of all cables in the conduit. This is a big factor in favor of the design of this solution.

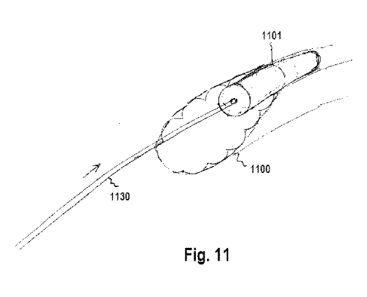

FIG. 11 shows how a steel rod can be used in place of a rope for specific tasks. The elements shown are duct 1100, shuttle 1101, rod 1130 and a special note here is that the vector of pulling tension on the shuttle, although not shown, is reversed and the shuttle is pushed through a duct, not pulled, although a rope attached from the far end could be used to pull in unison. This can prove useful for bends in long runs of duct, to navigate through.

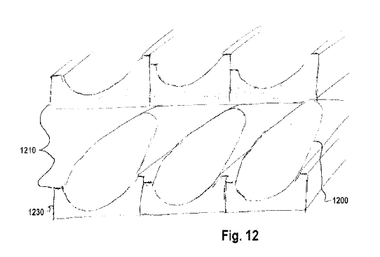

FIG. 12 shows that braces can be useful to hold the ducts in a given placement for burial, or for encasement in a media 1210 such as tamped gravel or concrete fill. The elements shown are ducts 1200 and braces 1230.

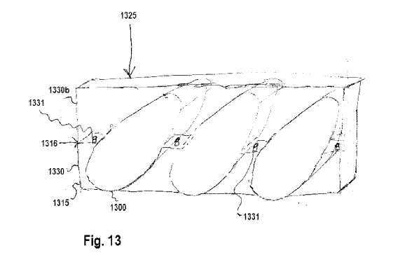

FIG. 13 shows further progression of FIG. 12 where pinning is needed to assure no shift during a heavy concrete pour. The elements shown are a duct 1300, a bottom half brace 1330 which is distinctly a different shape from a top half brace 1330b and a dowel pin 1331. The load 1325 marked on the figure is more representative of both the concrete, any back fill and such things as roadways, walkways or crossing pipelines and other duct systems which, by way of their sheer mass and settling over the years, would cause damage to the ducts. Dowel pin size and material selection may vary per civil engineering requiring the sizing necessary to anticipate earth quake and other seismic activity. Also shown are truss 1315 and split 1316 for a two-piece duct bank.

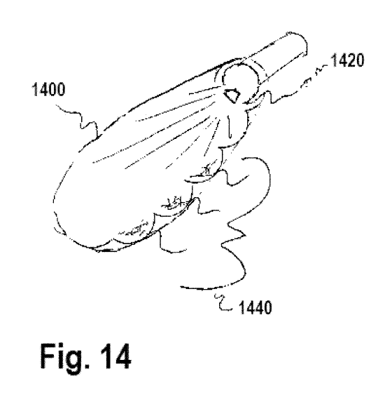

FIG. 14 shows the efficiency spread of lubrication from a shuttle equipped to deliver lubrication. The elements are 1400 duct, 1420 spray nozzle, 1440 where lubricant pools precisely where it is most advantageous due to gravity, the perfect place for subsequent cable pulling as this is precisely where gravity will assure the new cables will preside. Not shown is a camera which could inspect afterwards or during the event.

For purposes of the present invention “cable” is taken to include a non-limiting continuum of service- or product-conveying flexible lines known to utility providers, installers and consumers, such as, for example, cable, optical fibers, copper, aluminum, steel solid or twisted wire, communications, digital, TV, power, fluidic or gas utility lines, or anything of marketable value that may be confined to a flexible element which is substantially characterized, for purposes of its service or product conveyed, by one-dimensional behavior. Other behavior in a second and/or third dimension, such as mechanical or thermal effects not directly connected to the service or product, is understood to have secondary importance.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

I claim:

1. A duct system for routing at least a first and a second flexible utility cables in a longitudinal cavity comprising at least one elliptically cross-sectioned conduit having a sufficient length and having sufficient torsional rigidity to retain, while leaning supported in said cavity, a major elliptical axis of said conduit in a sufficiently angled orientation with respect to vertical to allow an action of gravity to favor the cross-sectional centers of said at least first and said second cables adopting an enhanced offset relation with respect to vertical and wherein said torsional rigidity is less than an amount which would prevent said major elliptical axis, for at least a portion of said length, from adopting a vertical orientation.

2. The duct system of claim 1 wherein said cables are selected from the list consisting of power cables, analog or digital communications cables and conduits of compressible or incompressible fluids.

3. The duct system of claim 1 further comprising an integrated service duct and at least one shuttle fitting in longitudinally movable relation to said service duct.

4. The duct system of claim 3 further comprising a robotic device mounted on said at least one shuttle.

5. The duct system of claim 4 further comprising a camera on said robotic device.

6. The duct system of claim 4 further comprising symmetrical grooving to the inner walls of the major and minor duct providing for traction of said robotic device.

7. The duct system of claim 4 further comprising at least one tool for performing at least one function selected from the list consisting of
cleaning, cutting, pulling, dispensing lubrication
nudging cables, removing kinks, grabbing a stone,
cleaning with water assisted by detergent or pressure,
vacuum cleaning, compressed air cleaning, grinding.

8. The duct system of claim 5 further comprising at least one tool for performing at least one function selected from the list consisting of
inspection, grinding.

9. The duct system of claim 4 further comprising a secondary power line.

10. The duct system of claim 1 further comprising termination points permitting termination of said ducts in a manner able to work within industry standards for installation of duct contents.

11. The duct system of claim 1 further comprising a second conduit in substantially seamless combination with said conduit for routing.

12. The duct system of claim 1 wherein said at least one cable further comprises a sheath and wherein a friction coefficient of a wall of said conduit is lower than the friction coefficient of the cable sheath.
